(19) United States
(12) Patent Application Publication
(10) Pub. No.: US 2014/0256391 A1
(43) Pub. Date: Sep. 11, 2014

(54) Casino Chess Game

(71) Applicant: Robert Valentine, Las Vegas, NV (US)

(72) Inventor: Robert Valentine, Las Vegas, NV (US)

(21) Appl. No.: 14/165,688

(22) Filed: Jan. 28, 2014

Related U.S. Application Data
(63) Continuation of application No. 13/081,484, filed on Apr. 6, 2011, now abandoned.
(60) Provisional application No. 61/325,393, filed on Apr. 19, 2010.

(51) Int. Cl. G07F 17/32

(52) U.S. Cl. CPC G07F 17/3279; G07F 17/3293; G07F 17/3295
USPC 463/11

(57) ABSTRACT

A casino game comprising a computing device comprising a controller for executing program instructions, a memory storing program instructions, a bus connected to the controller and the memory, a display device connected to the bus, and an input device connected to the bus, the computing device further comprising a device for accepting payment of funds to wager bets, the display device displaying a chess board and a plurality of chess pieces displayed on the board, the display device further displaying a plurality of cards with at least one of the plurality of cards including a chess piece indicia on the respective card, the display device displaying dealing the cards to a first player and dealing the cards to the second player, wherein the second player is optionally a computer player, the first player depositing funds into the device and using the input device to bet an ante bet into a pot, alternating moving a chess piece on the board based on the card selected by the first and the second player according to a traditional set of rules of chess, wherein a second piece cannot be moved that is not described as the chess piece on the card, betting when drawing at least one card and placing funds into the pot, wherein the other player matches the bet, increases the bet or surrenders, wherein if the surrender occurs the betting player wins; and wherein the player wins the casino game by capturing a king chess piece and a queen chess piece of the opponent, and the winning player wins an amount of the pot.

### CROSS REFERENCE TO RELATED PATENT APPLICATIONS

The instant patent application is a continuation of U.S. NON-PROVISIONAL patent application Ser. No. 13/081,484 entitled “Casino Chess Game” having a filing date of Apr. 6, 2011 which claims priority to U.S. Provisional Patent Application Ser. No. 61/325,393 entitled “Casino Chess Game” having a filing date of Apr. 19, 2010, which is herein incorporated by reference in its entirety.

### FIELD OF THE INVENTION

The present disclosure is directed to a chess game for a casino. More particularly, the present disclosure is directed to an unpredictable chess game that introduces wagering and increases the speed of the game to make chess more suitable for a casino.

### BACKGROUND OF THE RELATED ART

United States Published Patent Application No. 2007/0126179 to Esserman et al., (hereinafter “Esserman”), which is incorporated by reference in its entirety discloses a chess game that introduces wagering. The game of Esserman et al. may be won by checkmate, making a bet that is not matched or by other reasons. In the Esserman et al. game, the players make an ante bet. After the ante, the players are only given a number of pieces and those pieces are placed on the board while other pieces of the board are left vacant. Thereafter, the player may place a bet on their perceived strength. During each move, a player can bet an incremental amount per move, or in a no limit variation, the player may bet a large amount. The game continues until such time as the opponent is checkmated or until such time as the player surrenders as the bet is too high. A player may be accorded with a chance arrangement. For example, only certain chess pieces may be placed on the board in a distribution while certain other spaces may be blocked off. This distribution may favor one player over the opponent. Esserman et al. is disfavored as the game restricts the chess game to a large extent. A player having only a few pieces on the board would not be motivated to play and bet since the outcome may be very limiting and bleak since a full complement of chess pieces is not present.

United States Published Patent Application No. 2008/0116636 to McCray (hereinafter “McCray”) discloses a casino chess game, which is also incorporated by reference in its entirety. The game includes a board, and two sets of pieces, which are engraved on poker chips that reflect the conventional chess pieces. Each of the pieces in the game may include a numerical score as shown in FIG. 4. A player may capture piece by piece of the opponent's pieces and receive numerical points. When the player checkmates the opponent, then the remaining pieces are tallied as well into the player's total. In one embodiment, each of the pieces may reflect a dollar amount and the player would win that amount in dollars.

United States Published Patent Application No. 2009/0020949 to Arias is also incorporated by reference in its entirety and discloses a dual card game with a chess game that is similar to “Texas Hold 'Em Poker”. In a first embodiment, there is a conventional chess board and chess pieces. The game also has cards, and the cards are played in a game that is similar to a rock, paper, and scissors game. In a second embodiment, there are regular conventional playing cards that are disposed on the chess board. Essentially, when playing there is a challenge board, and to capture a piece in an opponent's territory, once must also win the challenge measured from the value of two cards one of which is arranged on the board. In a different embodiment, the participant may also play chess and a poker game at the same time.

U.S. Pat. No. 7,296,798 to Overfield is also incorporated by reference and discloses a modified chess game that also includes a set of cards. The chess pieces can be played and when a piece attacks another piece, the chess piece is not automatically awarded to the winner. Instead, a card game is commenced, and the winner of the card game is then awarded the piece.

U.S. Pat. No. 6,719,289 to Brown also incorporated by reference in its entirety and discloses a chess like game whereby cards are dealt in addition to the chess pieces that are disposed on a board. The cards that are dealt dictate the manner in which a chess piece is moved.

U.S. Pat. No. 5,011,159 to Fortunato et al. also incorporated by reference in its entirety and discloses a chess like game whereby a dice is rolled that determines the chess piece that can be moved. Additionally, the chess game can be played for a money pot. For example, a dice rolls a two and a three count. This is meant that the chess piece on the two, three or five location on the board can be moved.

All of the above patents and published patent applications are not well suited to a casino game whereby a long drawn out traditional chess match is too long of a game in duration for a casino. Moreover, the rules and strategy involved for a casino game make the chess game very difficult for a layman to play. However, the game chess is truly loved the world over, popular and a chess game that is fast and more suited to a betting environment would be highly desired and would be highly profitable to a casino and would attract gamblers. Further, the above games do not integrate betting into the games that is satisfying for a player in a casino. These attributes are corrected by the instant disclosure.

### SUMMARY OF THE INVENTION

There is a need in the art for a casino game that is unpredictable. There is a need in the art for a casino game that integrates chess and wagering and that will draw new players into a casino. There is also a need for an exciting game that involves strategy and that involves skill, which is exciting and faster to play than a full game of traditional chess.

According to a first aspect of the present disclosure, there is provided a method of playing a casino game. The method comprises providing a board and providing a plurality of chess pieces on a board. Cards are provided with at least one of the plurality of cards including chess piece indicia on the respective card. Cards are selected for a first player and dealt to the first player. Cards are selected for a second player and dealt to the second player.

The casino game includes alternating moving a chess piece on the board based on the card by the first and the second player according to a traditional set of rules of chess. A second piece cannot be moved that is not described as the chess piece on the card. The casino game involves betting when drawing at least one card and the other player can match the bet, can increase the bet, or may surrender. If the surrender occurs the betting player wins the casino game. The betting forms a pot and a player can win the casino game by capturing a king chess piece and a queen chess piece of the opponent whereby the winning player wins an amount of the pot.

In yet another aspect of the present disclosure there is provided a casino game. The casino game comprises a board and a plurality of chess pieces on the board. The game also has a plurality of cards with at least one of the plurality of cards including chess piece indicia on the respective card. The casino game includes dealing the cards to the first player and dealing the cards to the second player and betting an ante bet into a pot for each player. The casino game involves alternating moving a chess piece on the board based on the card selected by the first and the second player according to a traditional set of rules of chess, wherein a second piece cannot be moved that is not described as the chess piece on the card.

Betting occurs when drawing at least one card and placing funds into the pot. The other player may then match the bet, increase the bet or surrender, wherein if the surrender occurs the betting player wins. The player wins the casino game by capturing a king chess piece and a queen chess piece of the opponent, and the winning player wins an amount of the pot.

In another embodiment of the present disclosure, there is provided a casino game, comprising a computing device. The computing device has a controller for executing program instructions, a memory storing program instructions, a bus connected to the controller and the memory, and a display device. The display device is connected to the bus. The computing device also includes an input device connected to the bus. The computing device further includes a device for accepting payment of funds to wager bets. The display device displays a chess board and displays a plurality of chess pieces on the board. The display device further displays a plurality of cards with at least one of the plurality of cards including chess piece indicia on the respective card. The display device displays dealing the cards to a first player. The display device shows dealing the cards to the second player. The second player is optionally a computer player or an individual.

The first player uses the input device to bet an ante bet into a pot. The first player and the second player use the input device and alternate moving a chess piece on the board based on the card selected by the first and the second player according to a traditional set of rules of chess. A second piece cannot be moved that is not described as the chess piece on the card. The first player or the second player controls the input device to bet when drawing at least one card. The bet funds are displayed and are placed into the pot. The other player controlling the input device has options to match the bet, increase the bet or to surrender. If the surrender occurs the betting player wins. The first player or the second player wins the casino game by capturing a king chess piece and a queen chess piece of the opponent. The winner receives an amount of the pot.

According to another aspect of the present disclosure there is provided a method of playing a game, comprising providing a board and providing a plurality of chess pieces on a board. The method includes providing a plurality of cards with at least one of the plurality of cards including chess piece indicia on the respective card. The method includes selecting a plurality of cards for a first player and dealing the cards to the first player. The method also includes selecting a plurality of cards for a second player and dealing the cards to the second player. The method includes alternating moving a chess piece on the board based on the card by the first and the second player according to a traditional set of rules of chess. A second piece cannot be moved that is not described as the chess piece on the card. The player wins the game by capturing a king chess piece and a queen chess piece of the opponent.

### BRIEF DESCRIPTION OF THE FIGURES

The foregoing and other objects, features and advantages of the invention will be apparent from the following more particular description of preferred embodiments of the invention, as illustrated in the accompanying drawings in which like reference characters refer to the same parts throughout different views. The drawings are not meant to limit the invention to particular mechanisms for carrying out the invention in practice, but rather, the drawings are illustrative of certain ways of performing the invention. Others will be readily apparent to those skilled in the art.

FIG. 1 shows a perspective view of the casino chess game for two players and a casino dealer;

FIG. 2A shows a perspective view of a first player having five cards whereby the player can only move a chess piece in the traditional manner described on the card and is restricted from moving other chess pieces not described on the card;

FIG. 2B shows a front view of a hand of five cards for playing the casino chess game;

FIG. 3 shows a pot having a number of betting chips and a discard pile with a number of cards that the first or second player has played indicating movement of a chess piece;

FIG. 4 shows a first and a second deck of cards for dealing out the first through fifth cards to the first and the second player;

FIG. 5 shows an arrangement of the casino chess game of FIG. 1, whereby a single dealer may be shared among three tables each having a first and a second player;

FIGS. 6-7 shows a number of chess pieces whereby the chess piece is on a single card to denote that the respective player may move that chess piece and is restricted from moving other chess pieces;

FIG. 8 shows a general purpose computer to play the casino chess game with a device for receiving funds for wagering; and

FIG. 9 shows an enlarged view of the chess pieces arranged on the chess board with a hand of cards in a computer implemented format of the casino game.

### DETAILED DESCRIPTION OF THE PREFERRED EMBODIMENTS

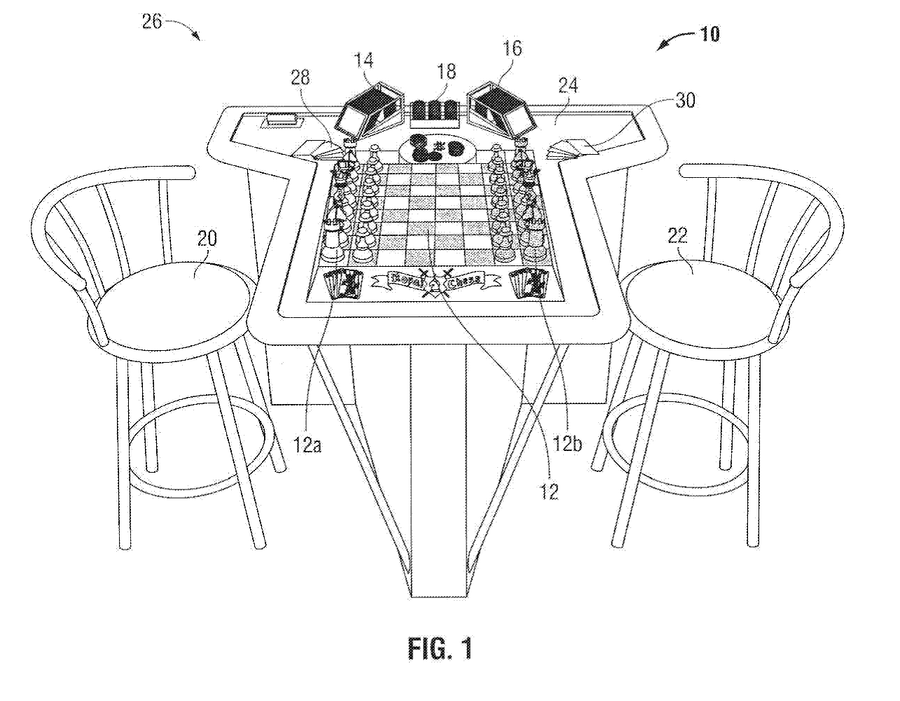

Turning to FIG. 1 there is shown a casino game 10. The casino game 10 includes a chess board 12, a number of playing cards (preferably two decks) with a first deck 14 and a second deck 16. Each card of the two decks 14 and 16 includes a figure of a chess piece on the card or some other chess piece indicia. The casino game 10 also includes chips 18 for betting. The chips 18 may include dollar chips, five dollar chips, ten dollar chips, twenty dollar chips, fifty dollar chips, hundred dollar chips and higher denominations. The casino game 10 may involve at least two players, or a first player 20 and a second player 22 that play on a table 24 or in an alternative embodiment a single player 20 may play the casino game 10 against a dealer 26. The players 20 and 22 may play against each other in a preferred embodiment or in a different embodiment; the first player 20 may play against the dealer 26.

Preferably, the chess board 12 is supported on the table 24 and includes a number of pieces generally shown as reference numeral 12a and 12b for each player 20 and 22. Preferably, the chess board 12 includes a number of (eight) pawns, two rooks, two knights, two bishops, a king and a queen (collectively shown as reference numeral 12a) for the first player 20. Additionally, the chess board 12 includes eight pawns, two rooks, two knights, two bishops, a king and a queen (collectively shown as reference numeral 12b) for the second player 22 (or alternatively for the dealer 26 in another embodiment where the dealer 26 plays against the first player 20). The pieces 12a and 12b are preferably moved according to the traditional rules of chess with certain exceptions described below to increase the excitement, the unpredictability and speed of the game for a casino environment. The official rules of chess are maintained by the World Chess Federation and are described in the FIDE (Federation Internationale des Echecs) Handbook, section Laws of Chess, which is incorporated by reference in its entirety.

The player for each side 20 and 22 initially may change paper money for a number of chips in certain denominations. The player for each side 20 and 22 is dealt five individual cards shown as “a hand” by reference numeral 28 and 30 “face down” so the five individual cards cannot be seen by the opponent but are revealed to the respective player 20 and 22. Each card of the five cards 28 and 30 includes indicia of a single chess piece on the card (for example, a hand 28 may include one card having a pawn, one card having a pawn, a third card having a rook, a fourth card having a bishop and a fifth card having a queen). Various different hands of five cards 28 and 30 may be formed and this is just one non-limiting embodiment of the present disclosure. These hands of cards 28 and 30 correspond to a single chess piece 12a and 12b that a player 20 and 22 may move during a turn. The other pieces 12a and 12b not described on the five cards of the hand 28 and 30 are restricted from being moved. This allows a player 20 and 22 to use a riskier strategy and promotes unpredictability and competition during the game.

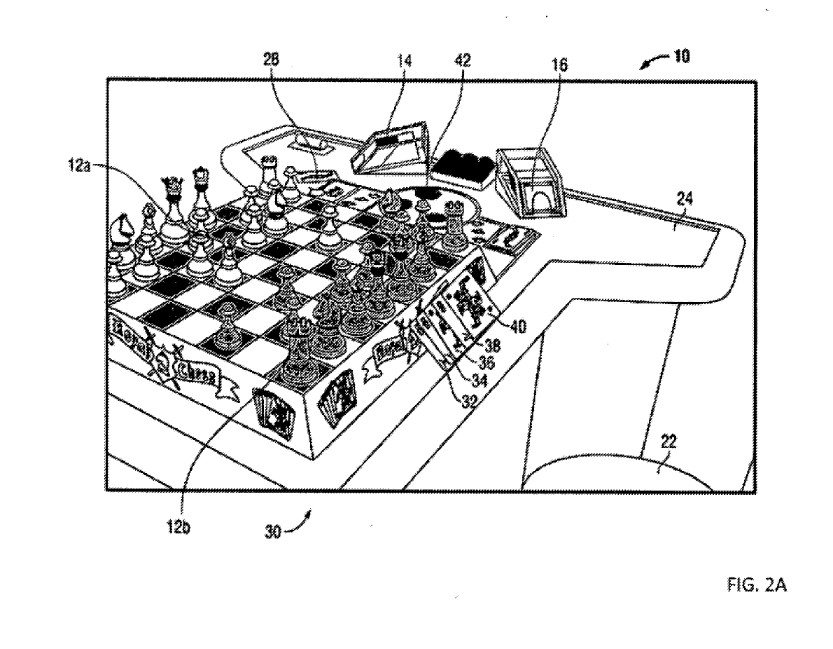

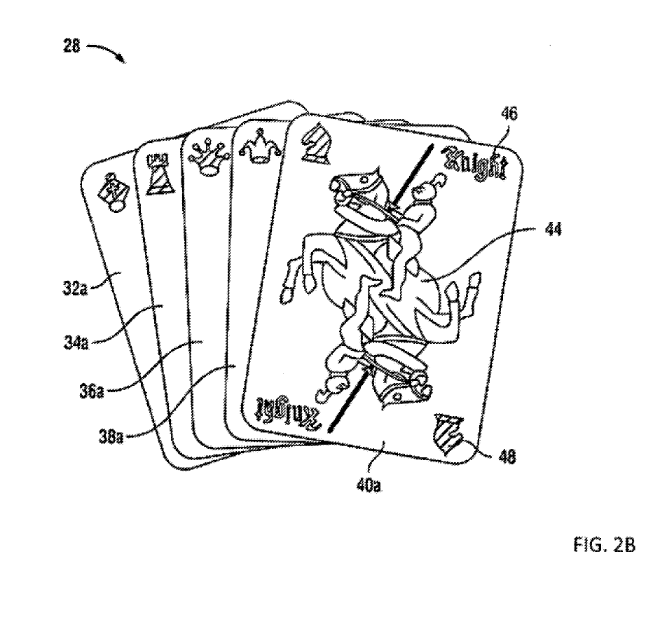

Turning now to FIG. 2A, there is shown a view from the perspective of the second player 22 where the second player 22 has a hand 30 of five cards 32 through 40 with each card 32-40 denoting a single chess piece indicia on the card, which may be an image, a figure of a chess piece, text describing the chess piece or the like. Various configurations are possible of indicia and within the scope of the present disclosure; for example, a King may be denoted by a single letter “K” or the like. At the start of the casino chess game 10, the players 20 and 22 or the dealer 26 decide the ante amount (i.e., one dollar, five dollars, etc.). Various tables may have different ante amounts, for example in the casino, one table 24 may have a one dollar ante while another may have a higher ante bet such as twenty dollars. Various configurations are possible and within the scope of the present disclosure. The ante amount is then placed in the pot 42 for each player 20 and 22. For example, the pot 42 can include ten dollars placed in by the first player 20 and ten dollars placed in by the second player 22 for a total of twenty dollars placed in the pot 42. If the ante was one hundred dollars, then the pot 42 would be two hundred dollars total.

Turning now to FIG. 2B, there is shown a different hand 28 for a first player 20. As can be seen, the first player 20 includes five cards as well hidden from view from the opponent 22 of FIG. 2A. The five cards may include a first through fifth cards 32a-40a with each including chess piece indicia (44, 46 and 48) on the respective card. The indicia may take various forms and be sufficient to communicate the identity of a single chess piece to the player 20 and 22 and dealer 26. The indicia can be a symbol of a chess piece 48, a picture of the chess piece 44, a single letter or character or text 46 that denotes the chess piece, i.e., “KNIGHT”. As can be seen by FIG. 2B, the first player 20 includes a hand 28 that has a bishop 32a, a rook 34a, a queen 36a, a joker or wildcard 38a (which denotes being able to move any chess piece legally on the chess board as described below, or which denotes being able to reclaim a piece), and a knight 40a. It should be appreciated that the first player 20 cannot move other chess pieces 12a on the board 12 and is restricted from doing so, unless the first player 20 has the chess piece 12a described on the card 32a-40a or unless the first player 20 plays the wildcard 38a. For example, the first player 20 may not move a pawn as the pawn is not described on any of the cards 32a-40a in the hand 28 shown in FIG. 2B unless the first player 20 plays the wildcard 38a.

Thus, the player 20 may have the choice of moving one of the five cards 32a-40a and is limited to being able to move only the chess pieces described in the hand 28 of five cards 32a-40a. After the ante bet, the player 20 playing the white chess pieces 12a moves first, and then after the move, the second player 22 moves and then the players alternate moves. All of the moves follow generally the traditional strategy for moving the pieces.

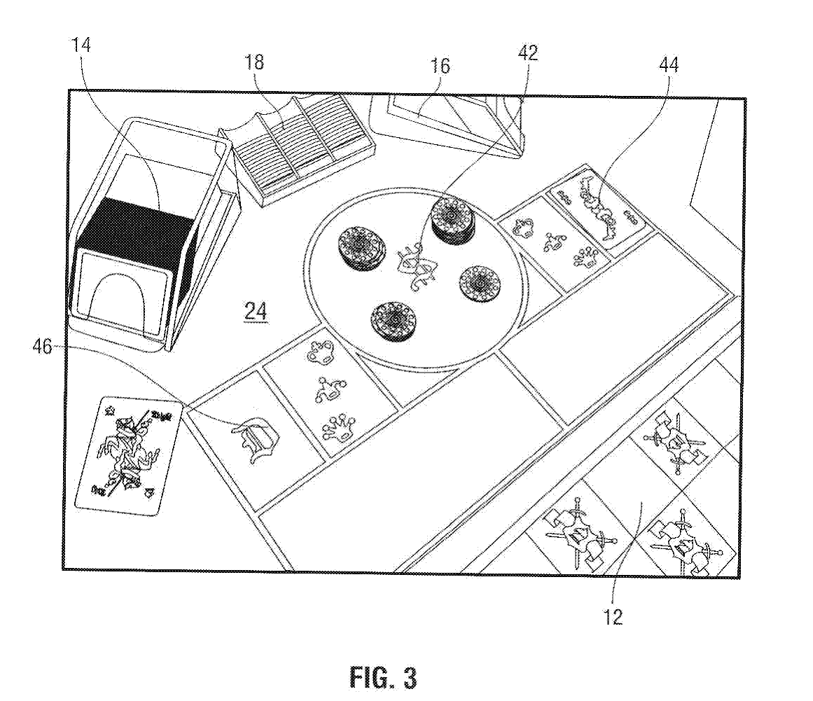

Turning now to FIG. 3, there is shown a close up view of the pot 42 and the discard piles 44 and 46, which are on the table 24. Once a card is played by the first or the second player 20 and 22 and is shown, then a desired chess piece 12a and 12b may be moved on the chess board 12 and the card that was just used is then discarded into the pile 44 or 46. For example, the first player 20 may show a pawn card, then move a pawn one space or two spaces on the chess board 12 and then discard the pawn card into the pile 46. Thereafter, after each move, the first player 20 always has five cards in the hand 28 to choose from and is dealt another card to replace the card that was just played from the deck 14 by the dealer 26. The chess piece 12a described on the card moves exactly in the same manner as under a traditional game of chess so the first player 22 may make strategic moves. However, at the same time the first player 20 does not know what cards 32-40 the second player 22 has in the hand 30, therefore the first player 20 does not know what the opponent 22 can or cannot move and vice versa. Therefore, the players 20 and 22 may take more chances than a traditional game of chess.

First and the second decks 14 and 16 shown in FIG. 3 include one hundred cards (or two decks of fifty cards per first and second player 20 and 22). Each deck 14 and 16 includes 100 hundred cards or 4 jester or wildcards cards, 6 king cards, 6 queen cards, 12 bishop cards, 12 knight cards, 12 rook cards, and 48 pawn cards. The decks 14 and 16 are shuffled thoroughly by hand or by a machine like SHUFFLEMASTER I-SHOE AUTO.COPYRGT. of Shuffle Master, Inc. of Las Vegas, Nev. or the like. In another embodiment, the decks 14 and 16 may include fifty cards. In yet another embodiment, if the decks 14 and 16 are exhausted, then the cards in the discard piles 44 and 46 are reshuffled and then used. In a further embodiment, the reverse side of each card may include advertising indicia or the name of the casino or the like.

For example, the bishop card 32a shown in FIG. 2B may be played and then the corresponding piece 12a may be moved into a threatening position by the first player 20 to capture an opponent's 22 piece (for example, to capture a knight chess piece on the board 12). However, the first player 20 may or may not have a wild card or a second bishop piece card to capture the knight piece. The opponent 22 may then panic and waste a knight card and play the knight card to move the knight piece from danger. Alternatively, the opponent 22 may use another card to move close to capture the first player's 20 attacking bishop piece to call the first player's 20 bluff. This leads to an enhanced level of playing and strategy that is not found in the prior art and leads to increase drama and skill to win the game. Although one player 20 or 22 may be a better chess player in a mechanical sense, the opponent may be a better bluffer or a better wager and this leads to enhanced competition, which is attractive.

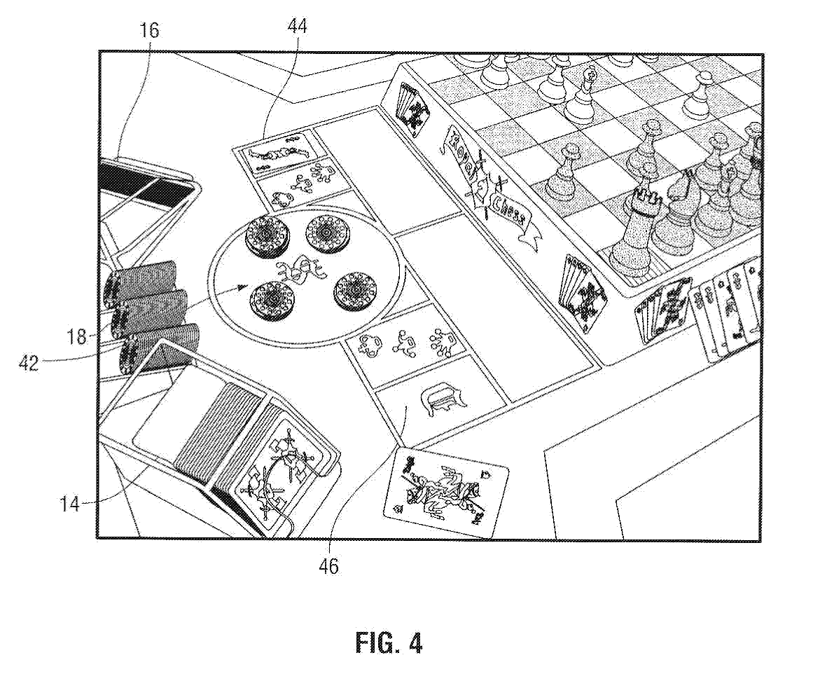

Turning now to FIG. 4, generally in one embodiment, the amount of the ante bet for the table becomes a standard betting amount for the table. In another embodiment, the standard better amount may be different than the ante bet. For example, if the ante bet is ten dollars then the standard bet is ten dollars per player 20 and 22 for the remainder of the game. As play progresses, when the king card, or queen card, or jester (wildcard) card is played by either player 20 and 22, a second bet may be made which is equal to the standard bet. For example, if the queen card is played by the second player 22 from the hand 30 (by placing the card in the discard pile 44) then the second player 22 may optionally bet the standard bet, or in this example, ten dollars, which is placed in the pot 42. The standard bet can be announced to the opponent 20 and then the amount is pushed into the pot 42, whereby the opponent 20 must match the amount of the standard bet, which is pushed into the pot 42 and then the queen chess piece is moved in a traditional manner by the second player 22. Then, another new card is dealt to the second player 22 by the dealer 26 to replace the discarded queen chess card from the deck 16.

The betting player may count up their betting cards and they may bet up to the number of betting cards played. For example, if two king cards and three queen cards for a total of five cards are in a hand 28 or 30 held by the first or the second player 20 and 22, then the player may bet up to $50 on that play total or the standard bet multiplied by five cards or may not place a bet at all.

If the jester card or wildcard 38a shown in FIG. 2B is played, then the betting amount can be double the amount of betting cards played. For example, if the first player 20 places a wildcard 38a down to move any chess piece on the board then double the standard amount may be wagered or twenty dollars (two times the standard bet). The opponent 22 may match the bet of the first player 22, may raise the bet, or may surrender which ends the game and the winner 20 may take the pot 42 shown in FIG. 4. At any time, the opponent 22 may surrender at the beginning of their turn (as they may feel they may lose or want out of the game as the pot 42 has become too rich) and the first player 20 wins the game and takes the pot 42 shown in FIG. 4.

Once the casino game 10 progresses, a player 20 or 22 may find that the five cards that the player 20 or 22 holds correspond to chess pieces 12a or 12b that the player cannot move. For that turn, a player 20 or 22 may pass, or discard a useless card and forfeit a turn and receive a new card from the deck 14 and 16. This may be accomplished as a form of strategy to force an opponent to move again or to build a stronger hand of cards. A card cannot be discarded as a pass card if that card can successfully move a chess piece 12a and 12b. Castling also may be accomplished by playing a king card by the first or second player 20 and 22.

Pieces may also be reclaimed by a pawn reaching a back row whereby the pawn is traded for a previously captured piece. Pieces may also be reclaimed by playing the jester or wildcard 38a. When reclaiming with the jester or wildcard 38a, the rook, the knight or the bishop piece must be placed on one of the two squares it occupied at the start of the game. If the square is occupied, then the reclaimed piece cannot be placed on the original location and the player 20 or 22 must wait until the appropriate square is available. The king and the queen piece may be reclaimed and placed at the original starting position, if vacant, however if an opponent's piece is located on the king or queen's original location on the chess board 12, then it cannot be reclaimed until such time as the original location becomes available. However, in the event that a player's 20 and 22 own piece occupies the king or queen's original space, then by playing the wildcard or joker 38a a king or a queen may be reclaimed and placed on the back row of the player's side. A pawn may not be reclaimed.

Otherwise, the game 10 continues until both the king chess piece and the queen chess piece are captured by the opponent. The game is modified slightly as there is no “check” move or “checkmate”, as both the king and the queen chess piece 12a, 12b must be captured to win and the king chess piece may be moved into danger. For example, a player 20 may capture opponent's 22 king and lose (which never happens in traditional chess) since the opponent 22 may capture the player's 20 king then queen chess piece. In the event of a stalemate, then the game 10 can be played over again. The players 20 and 22 have the option of receiving their money back in a stalemate or play the casino game 10 in a “let it ride” format whereby the money is left in the pot 42 and is joined with the new ante and new standard bets (which are added into the previous pot 42). Generally, the house or dealer 26 can receive ten percent of the winnings; while the winner stays on to play a new challenger. In yet another less preferable embodiment, the casino chess game 10 may be won by only capturing an opponent's king chess piece.

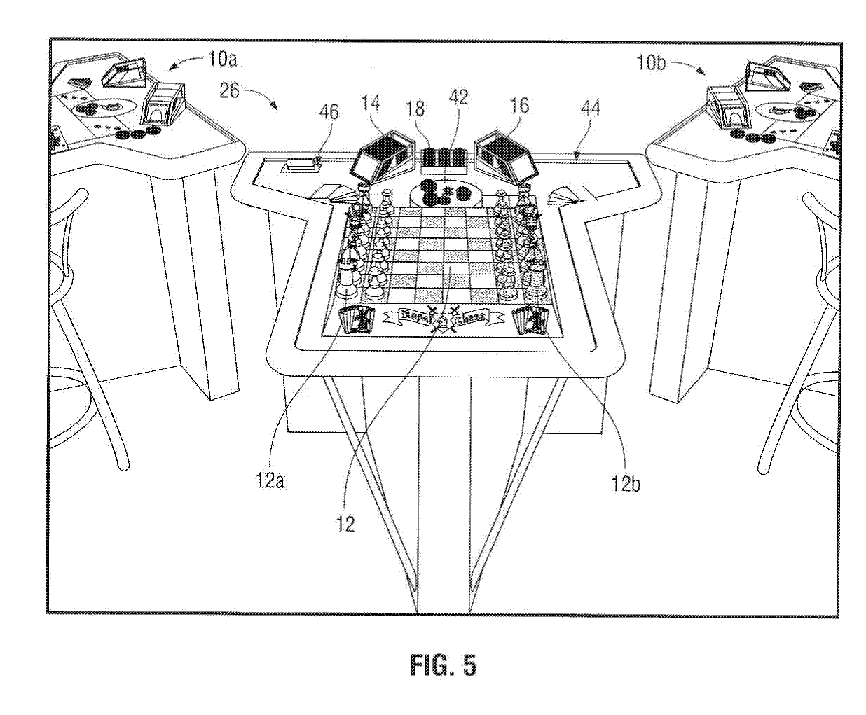

Turning now to FIG. 5, as shown the chess pieces 12a and 12b are set up in a traditional manner with the black queen on the black square and the white queen on the white square and the dealer 26 may service a second table 10a with two players and a third table 10b with two players with a similar format to that described in FIG. 1.

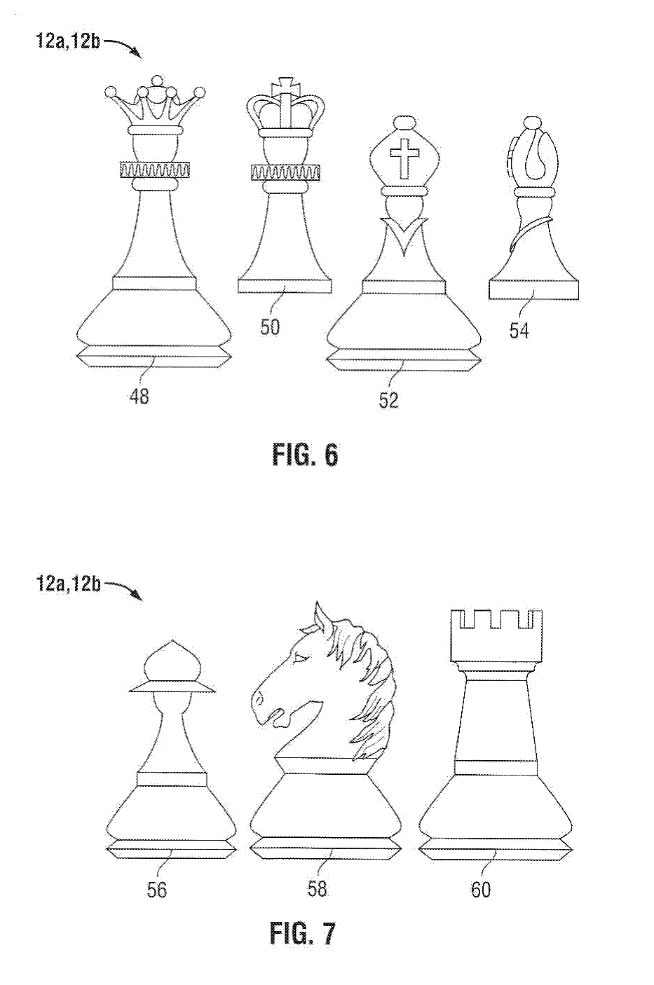

Turning now to FIG. 6-7, there is shown a close up view of respective chess pieces 12a and 12b including a queen piece 48, a king piece 50, two bishop pieces 52 and 54, a pawn piece 56, a knight piece 58, and a rook piece 60. Various configurations are possible for the chess pieces 12a, 12b and different shapes are within the scope of the present disclosure.

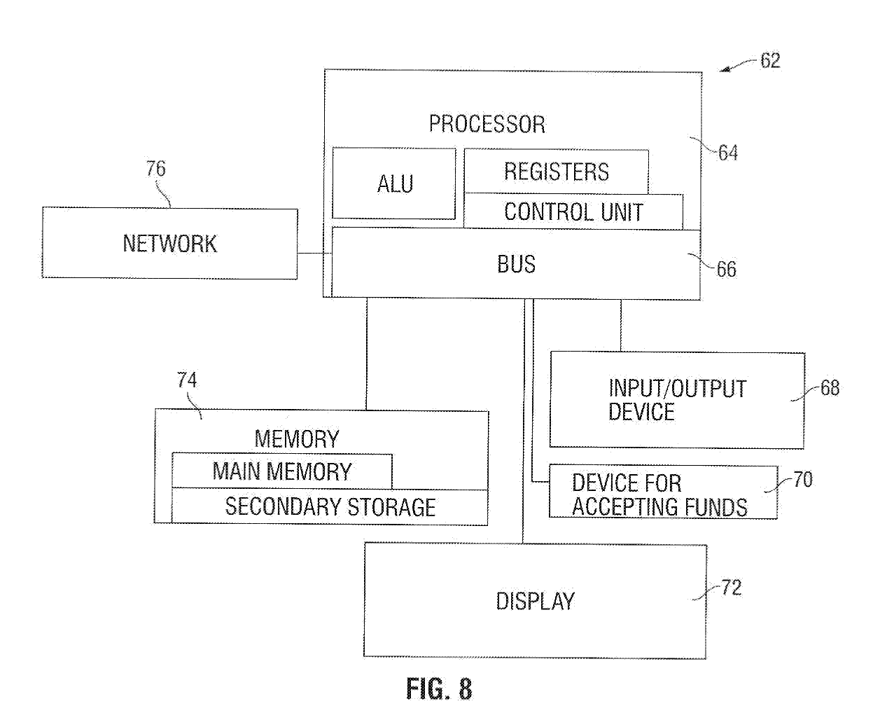

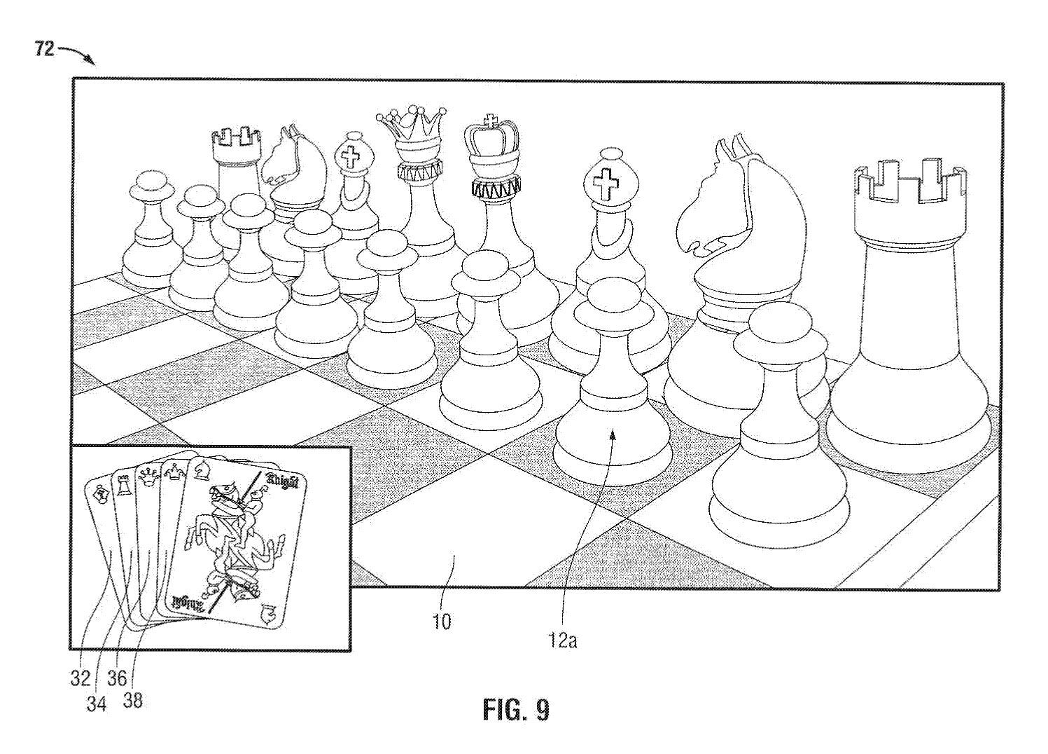

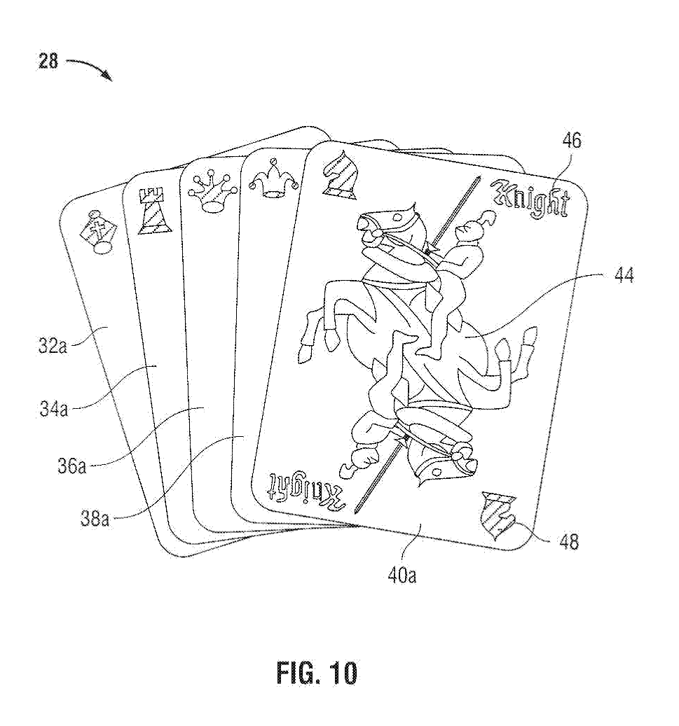

Turning now to FIG. 8-9, there is shown a general purpose computer 62 to be used with certain aspects of the casino chess game 10 and method of the present disclosure. It should be appreciated that the present casino chess game 10 is not limited to a physical game and may be played on a slot type machine or on a mobile computer device, or using a general purpose computer at the home or office. The present disclosure may be implemented on a computer system 62. The computer system 62 preferably includes the generic components of most general purpose computers.

The computer system 62 comprises an interconnection mechanism, such as a bus 66, or circuitry which couples to an input device 68, such as a keyboard or touch screen interface. The system 62 also has a processor 64 (such as a microprocessor having an arithmetic logic unit, a register and a control unit). The computer 62 also includes a storage device or memory 74 (such as a computer disk for a main memory and secondary storage) and an optional output device such as a monitor or screen 72. Generally, the bus 66 may be connected to a network 76 or the internet. In this manner, the device 62 also includes a device for accepting funds 70 for wagering. Device 70 may be a coin slot, a device for accepting bills, or a card reader for accepting electronic funds. Device 70 is optional and the system 62 may be programmed to allocate certain credits to the player 20 and 22 whereby the funds area paid to a different entity. Device 70 preferably sends a signal to the processor 62 upon receiving funds. FIG. 9 shows a number of chess pieces 12a arranged on a board 10 with cards 32-40 that are all output via the display 72 whereby the player 20 may play against the computer or may play against a second player according to the rules using the input device 68 described above.

Generally, in operation, the computer system operable with that method shown in FIGS. 8-9 is controlled by an operating system. Typical examples of operating systems are MS-DOS, Windows95, 98, 2000, XP, Vista and Windows 7 from Microsoft Corporation, or Solaris and SunOS from Sun Microsystems, Inc., UNIX based operating systems, LINUX based operating systems, or the Apple OSX from Apple Corporation. As the computer system operates, input such as input search data, database record data, programs and commands, received from users or other processing systems, are stored on storage device. Certain commands cause the processor to retrieve and execute the stored programs. The programs executing on the processor may obtain more data from the same or a different input device, such as a network connection. The programs may also access data in a database for example, and commands and other input data may cause the processor to index, search and perform other operations on the database in relation to other input data. Data may be generated which is sent to the output device for display to the user or for transmission to another computer system or device. Typical examples of the computer system are personal computers and workstations, hand-held computers, dedicated computers designed for a specific purpose, and large main frame computers suited for use many users. The present invention is not limited to being implemented on any specific type of computer system or data processing device.

It is noted that the present invention may also be implemented in hardware or circuitry which embodies the logic and processing disclosed herein, or alternatively, the present invention may be implemented in software in the form of a computer program stored on a computer readable medium such as a storage device. In the later case, the present invention in the form of computer program logic and executable instructions is read and executed by the processor and instructs the computer system to perform the functionality disclosed as the invention herein. If the present invention is embodied as a computer program, the computer program logic is not limited to being implemented in any specific programming language. For example, commonly used programming languages such as C, C++, JAVA as well as others may be used to implement the logic and functionality of the present invention. Furthermore, the subject matter of the present invention is not limited to currently existing computer processing devices or programming languages, but rather, is meant to be able to be implemented in many different types of environments in both hardware and software.

Furthermore, combinations of embodiments of the invention may be divided into specific functions and implemented on different individual computer processing devices and systems which may be interconnected to communicate and interact with each other. Dividing up the functionality of the invention between several different computers is meant to be covered within the scope of the invention.

While this invention has been particularly shown and described with references to a preferred embodiment thereof, it will be understood by those skilled in the art that is made therein without departing from the spirit and scope of the invention as defined by the following claims.

What is claimed is:

1. A program storage device readable by a machine, tangibly embodying a program of instructions executable by the machine for causing operations, said operations comprising:
displaying a plurality of chess pieces on an elevated chess board;
displaying a plurality of cards with at least one of the plurality of cards configured to indicate one of the plurality of chess pieces on the respective card,
wherein the casino game is configured for receiving input from the first and second player comprising:
selecting a plurality of cards for a first player and dealing the cards to the first player;
selecting a plurality of cards for a second player and dealing the cards to the second player;
alternating moving a chess piece on the elevated chess board based on the card by the first and the second player according to a traditional set of rules of chess,
wherein a second chess piece cannot be moved on the elevated chess board that is not described as the chess piece on the respective card;
betting when drawing at least one of the plurality of card, the betting forming a pot; wherein the other player matches the bet, increases the bet or surrenders,
wherein if the surrender occurs the betting player wins; and
wherein the player wins the casino game by capturing a king chess piece and a queen chess piece of the opponent, and the winning player wins an amount of the pot,
wherein if five cards are dealt to each of the players, each of the five cards comprising one chess piece indicia on the respective card, the chess piece indicia including the text or image or symbol relating to a first through fifth chess piece, wherein then the first or the second player can only move those chess pieces identified by the card and no other piece per turn, and after moving the piece, the player discharging the card receives a new card from the plurality of cards to move a new piece in a next turn.

2. The program storage device of claim 1, further comprising:
an entity associated with the casino that sponsors the casino game, and wherein the entity that sponsors the casino game keeps ten percent of the pot and the winner keeps a remainder of the pot.

3. The program storage device of claim 1, wherein the cards include a chess piece indicia, wherein the chess piece indicia comprises at least one of an image, a symbol, or text of a king, a queen, a bishop, a rook, a knight, and a pawn, wherein the chess piece indicia identifies only one piece per card.

4. The program storage device of claim 1, wherein five cards are dealt to the first player and the second player.

5. The program storage device of claim 1, wherein the plurality of cards are dealt face down to the respective player only, and wherein the chess piece indicia on the card is hidden from the opponent.

6. The program storage device of claim 1, wherein the player that wins the casino game stays on to play a third player in a new game.

7. The program storage device of claim 1, further comprising betting an ante amount at the start of the game, and placing the ante amount into the pot.

8. The program storage device of claim 1, further comprising:
playing with a wildcard in the plurality of cards, and wherein the wildcard denotes (i) freely moving any chess piece legally on the board that has not been captured in an unrestricted manner consistent with the traditional rules of chess or (ii) reclaiming a captured chess piece.

9. The program storage device of claim 8, wherein the bet is a fixed betting amount per round, and wherein the bet occurs only when a predetermined card of the plurality of cards is played, and further comprising optionally betting double the single fixed bet amount when the wildcard is played.

10. The program storage device of claim 10, wherein the plurality of cards include a discharge pile, and wherein after at least one card is played placing the played card in the discharge pile; and
wherein in the event that all of the cards of the plurality of cards have been played then further comprising reshuffling the plurality of cards in the discharge pile and drawing from the reshuffled plurality of cards; and wherein at a commencement of the casino game the plurality of cards originate from at least two decks of cards.

11. The program storage device of claim 10, wherein at least one player is a casino dealer.

12. The program storage device of claim 1, wherein in a stalemate situation wherein neither the first nor the second player wins the casino game, then further comprising replaying the game in a second game with the pot awarded to the winner of the second game.

13. The program storage device of claim 1, wherein the betting amount includes no limit.

14. The program storage device of claim 1, wherein each player bets a predetermined amount and wherein the predetermined amount is the same as an amount bet during an ante bet.

15. The program storage device of claim 1, wherein the first or the second player moves a chess piece to be close to a second opponent's piece to capture the second opponent chess piece according to the traditional rules of chess, wherein the first or the second player is unable to take the chess piece because the player does not have the card to move the chess piece to capture the second opponent chess piece, wherein the first or the second player bluffs the opponent into moving the second opponent chess piece to avoid capture.

16. The program storage device of claim 1, further comprising displaying advertising on at least one of the board and on the cards, wherein the advertising is associated with the casino.

17. The program storage device of claim 1, wherein the elevated chess board is configured to allow the first and second player to lay-out their respective cards without either player seeing the others cards.

18. A casino game, comprising:
a computing device comprising a controller for executing program instructions, a memory storing program instructions, a bus connected to the controller and the memory, a display device connected to the bus, and an input device connected to the bus;
the computing device further comprising a device for accepting payment of funds to wager bets;
the display device displaying a chess board and a plurality of chess pieces displayed on the board, the display device further displaying a plurality of cards with at least one of the plurality of cards including a chess piece indicia on the respective card;
the display device displaying dealing the cards to a first player and dealing the cards to the second player, wherein the second player is optionally a computer player;
the first player depositing funds into the device and using the input device to bet an ante bet into a pot;
alternating moving a chess piece on the board based on the card selected by the first and the second player according to a traditional set of rules of chess, wherein a second piece cannot be moved that is not described as the chess piece on the card;
betting when drawing at least one card and placing funds into the pot;
wherein the other player matches the bet, increases the bet or surrenders, wherein if the surrender occurs the betting player wins; and
wherein the player wins the casino game by capturing a king chess piece and a queen chess piece of the opponent, and the winning player wins an amount of the pot.
